(19) United States
(12) Patent Application Publication
(10) Pub. No.: US 2019/0126509 A1
(43) Pub. Date: May 2, 2019

(54) Method of Making Metal Objects by Casting

(71) Applicant: Daniel Gelbart, Vancouver (CA)

(72) Inventor: Daniel Gelbart, Vancouver (CA)

(21) Appl. No.: 16/150,055

(22) Filed: Oct. 2, 2018

Related U.S. Application Data
(60) Provisional application No. 62/578,488, filed on Oct. 29, 2017.

(51) Int. Cl. B28B 1/00; B22C 5/18; B28B 17/00; C04B 35/04; C04B 35/10

(52) U.S. Cl. CPC B28B 1/001; B22C 5/18; B33Y 10/00; C04B 35/04; C04B 35/10; B28B 17/0081

(57) ABSTRACT

A 3D printer creates a ceramic casting shell of high accuracy. Casting molten metal into this shell creates an accurate metal object. The ceramic shell is formed from a paste made from a low hardness ceramic, dried by freeze drying. To overcome the shear thinning behaviour of ceramic pastes a positive displacement pump is in close proximity to the nozzle.

### BACKGROUND OF THE INVENTION

The invention relates to the field of 3D printing of metal objects, also known as “additive manufacturing” or “rapid prototyping”. In 3D printing, a 3D object is created by building it layer by layer. The name “3D printer” in this disclosure should be widely interpreted as any system that generates a 3D object from computer data. There were several attempts to 3D print ceramic molds or shells and cast metal into them to create metal objects. Prior art approaches used jetting of a binder onto a powder bed to generate a ceramic mold, however molds were rough and weak and needed many steps to strengthen them. The traditional way of casting into a ceramic shell is known as investment casting, or lost wax casting. This process was used for thousands of years with excellent results; however, it is a labor intensive and slow process comprising of many steps. The current invention overcomes these problems by extruding premixed ceramic paste using a 3D printer to build a casting shell in a single step. One of the difficulties in direct extrusion is the “shear thinning” behavior of ceramic pastes. Another problem when using ceramic materials is shrinkage and distortion during drying. A third problem is the abrasive nature of most common ceramics such as alumina, silica, zirconia etc. Most ceramics are high hardness materials and even when ground to a very fine powder act as abrasives. The invention solves all these problems in an economical way and allows the fabrication of ceramic objects of arbitrary shape at high speeds and high dimensional accuracy. The invention is particularly useful for the creation of metal casting ceramic shells, similar to shell casting and investment casting. Shell casting uses sand with a phenolic binder to create a thin shell into which the molten metal is cast. It is limited to parts without complex internal structures. Investment casting, also known as lost wax castings, allows the creation of complex objects however the current process has many steps and the time to make a casting shell is long (5-10 days) because of the need to dry multiple layers of ceramic slurry.

### SUMMARY OF THE INVENTION

A 3D printer creates a ceramic casting shell of high accuracy. Casting molten metal into this shell creates an accurate metal object. The ceramic shell is formed from a paste made from a low hardness ceramic, dried by freeze drying. To overcome the shear thinning behaviour of ceramic pastes a positive displacement pump is in close proximity to the nozzle.

### BRIEF DESCRIPTION OF THE DRAWINGS

FIG. 1 is a general view of the invention, not including the enclosure, computer controls and dryer.

FIG. 2 is a cross-section of the nozzle, pump and shell.

### DETAILED DESCRIPTION

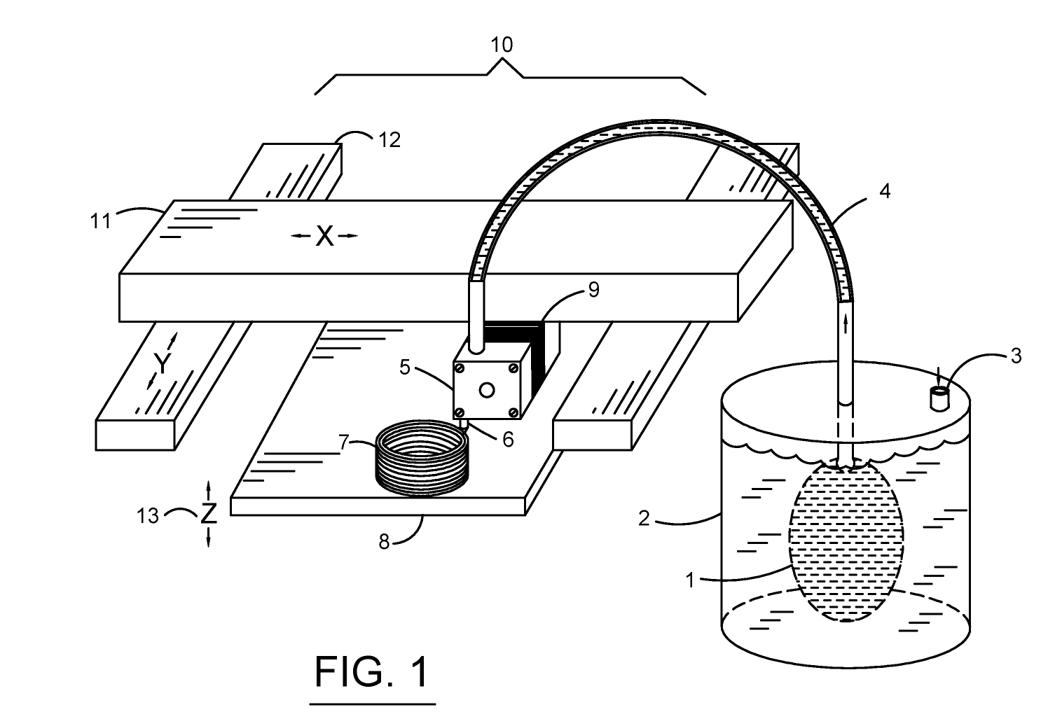

Referring to FIG. 1, a ceramic paste is placed in bag 1. The bag is inside pressure vessel 2 pressurized via tube 3 by air or water. The ceramic paste is forced out of the bag and fed via flexible tube 4 to metering pump 5 mounted on a 3D printer 10 of the well known FDM (Fused Deposition Modelling) type. No further details of the printer mechanism are given as this is a commercial product available from dozens of vendors. The stepper motor 9 used for filament feeding on an FDM printer an be used to drive the metering pump 5 equipped with nozzle 6. The ceramic paste feeder 1 can be a commercial paint feeder commonly used by painters. Shell 7 is built up in a similar manner to building a plastic object in an FDM printer. Printer 10 is preferably of the type that the build plate 8 is the slowest moving axis (Z axis 13) while X axis 11 and Y axis 12 are fast moving.

In order to avoid shrinkage and distortion during drying of object 7, freeze drying is used. This is a commercial process combining fast freezing at a very low temperature (about −50 degrees C.) followed by applying a vacuum to sublimate the water and slowly heating the drying part to accelerate the drying. Commercial freeze dryers suitable for current invention are readily available, their typically used to dry food. Well known suppliers are Labconco Corp (USA) and Harvest Right (USA).

When freeze drying is used, the process can be accelerated by keeping the area above build table 8 at a low temperature, preferably sub zero, by blowing chilled air at the nozzle or other means, e.g. placing the complete machine in a refrigerated chamber. It is possible to generate different resolutions from a single nozzle. The reason it is possible to generate a different deposited line width from the same nozzle size is that the deposited line diameter is a function of two parameters: flow rate and relative motion speed between nozzle and object. A slow motion and a high flow rate will create a thick line, as a large amount of material is deposited per unit length. A low flow and high motion speed will generate a thin deposited line, as needed for high resolution. The flow rate is controlled by the metering pump 5. While FIG. 1 shows a single nozzle, a typical machine will have 2 nozzles. The reason is that for many shapes a temporary structure, known as a support structure, needs to be deposited. This structure is made from a very weak ceramic, typically a mixture of talc and water without any binder, so it can be easily removed from the shell after it is dry.

Sometimes novel properties can be achieved by co-deposition of materials. For example, interleaved deposition of two reactive materials, such as a ceramic paste and an activator fluid. This can be handled by multiple nozzles. Also, several nozzles allow deposition of several types of ceramic pastes without needing to clean the nozzle.

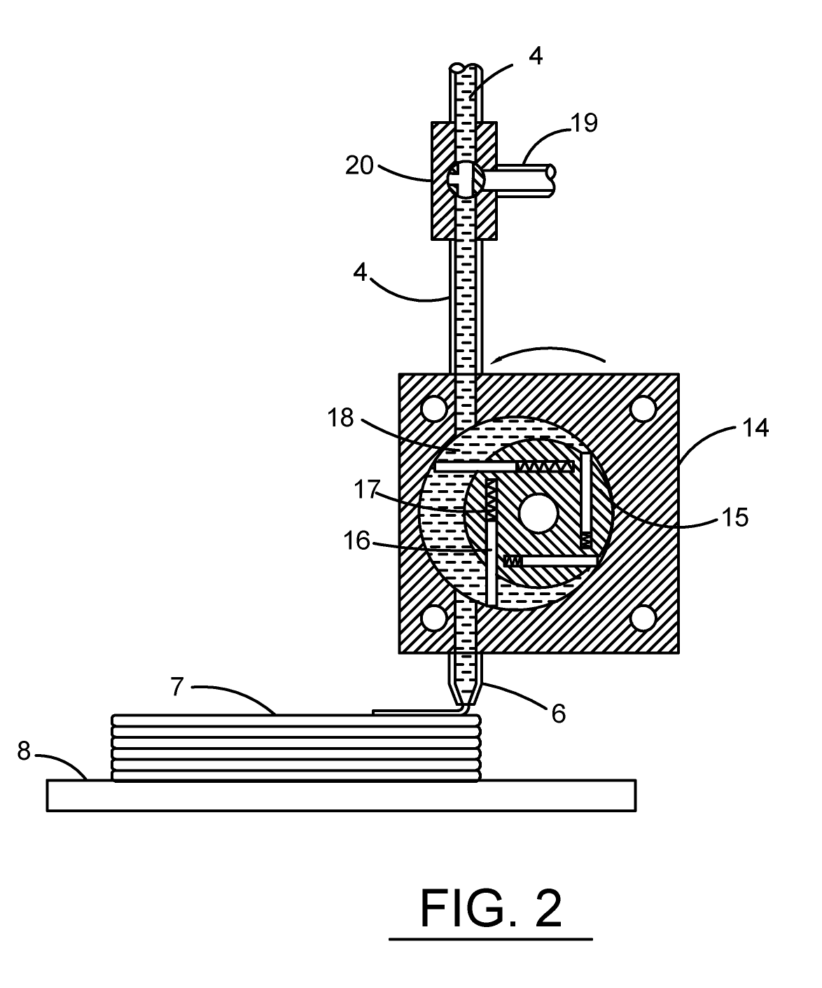

The details of the nozzle and pump are shown in FIG. 2. Because of the strong shear-thinning behaviour of ceramic pastes a pump located as close as possible to the nozzle is desired. The preferred pump 5 is a vane pump, comprising of pump body 14, eccentrically placed rotor 15 with vanes 16 loaded by springs 17. Such pumps are well known and commercially available. Pressurized ceramic paste arrives in tube 4 (typical pressure 10 atmospheres) and metered by pump 5 to nozzle 6. The orifice of nozzle 6 is typically between 0.3 mm to 0.8 mm. The pump and nozzle are typically made of hardened type 440C stainless steel. A pump with low pressure pulsation is desired. This is achieved by widening the input and output ports. Since the paste can dry in the nozzle when not in used for several hours, it is desired to automatically flush the pump and nozzle with water before shutting system down. 3 way valve 20 allows to feed pressurized water from port 19 into the pump to clean it out. Pump 5 is typically driven from a stepper motor similar to the filament feed motor in an FDM printer, however it is desired to gear the motor down by a high ratio (typically 5:1 to 50:1) to achieve greater torque. It is most important to place the pump in close proximity to the nozzle, to minimize the amount of trapped paste between the pump and the nozzle. The ceramic paste is somewhat compressible, causing some material being extruded after pump is stopped. Some of the effect can be cancelled by reversing the pump for a short time after stopping, but minimizing the trapped volume between pump and nozzle is critical.

The preferred embodiment uses a vane pump but many other types of positive displacement pumps can be used, such as a swash-plate pump, a progressive cavity pump, a peristaltic pump or any other type of small flow high pressure positive displacement pump.

When the shell 7 has horizontal surfaces a support structure 26 is usually needed. The preferred method uses a separate feeder, pump and nozzle for the support material. The art of automatically designing the supports is well known in 3D printing. It is desired that the ceramic materials used for the shells should have the following properties:
1. Low cost, as the shell is discarded and cost of most parts must remain low.
2. Low hardness, in order not to cause wear in the nozzles.
3. High temperature and high thermal shock capability. For non-ferrous metals such as aluminum, brass, bronze, gold, silver, copper etc the shell must withstand about 1200 deg C. for a short time. For steel, stainless steel and titanium the shell must withstand 1800 deg C. for a short time.
4. Controlled strength. The shell must be strong enough to withstand the hydrostatic pressure of the molten metal but weak enough to be easily removed from the finished casting by cracking (for outside surfaces) and breaking up or sandblasting for inner passages or cavities.
5. Low toxicity, as it is desired to be able to discard the broken shells as landfill or any other unrestricted disposal.

It was found that to meet these requirements it is best to use material with a Moh scale hardness below 6, and preferably below 3. It was also found out that for best results the ceramic paste should comprise a base material, water, a binder and a lubricant. The binder can be organic, inorganic or a mixture of both. It was also found out that adding water increases be porosity of the shell after drying, which is highly desirable for a casting shell as the hot gasses created in the casting process can escape. The best base materials were found to be Talc (Moh hardness of 1), Kaolin (Moh hardness of about 2.5) and Magnesium oxide (Moh hardness of about 5.8). The best inorganic binders were Sodium Silicate, Potassium Silicate, Aluminum Oxide Hydroxide and Vee Gum (Magnesium Aluminum Silicate). The best organic binders were Arabic Gum, Poly Vinyl Acetate, Poly Vinyl Alcohol and water based Phenolics. The lubricant is added is small quantities to prolong pump life. Out of the large number of possible ceramic materials the following three gave the best results:

For Non-Ferrous Castings:
1. Talc+1 part Sodium Silicate+2 parts water. The talc is added to the solution until a thick paste is created. Paste has to be thick enough to form free standing walls of several centimeters. The talc is fine particle talc, with average particle size of 3 um. Talc used was Cimpact 699 supplied by the Imrys corporation. Average particle size is 3 um. After paste is mixed 1% to 5% of machine oil is added as a lubricant and paste re-mixed, preferably in a vacuum mixer. Any type of lubricating oil can be used, a highly volatile oil is preferred.

This ceramic is best under 1000 deg C. but for small castings that cool rapidly it can be used to 1200 deg C.
2. 38% Talc+13% Vee Gum+4% Sodium Silicate+40% water+5% SAE20 motor oil. Same preparation instructions as #1.

For Ferrous and Other High Temperature Castings:
1. Magnesium Oxide (nanoparticles or micron range particles)+Aluminum oxide hydroxide, AlO(OH) added until a thick paste is formed, add 1-5% motor oil as a lubricant.
2. 28% Kaolin+23% ball clay+1% Poly Vinyl Alcohol+1% AlO(OH)+1% Gum Arabic+42% water+4% motor oil as lubricant.
3. 1 part Magnesium Oxide nanoparticles (20-100 nm size range)+2 parts Talc+water to form a thick paste, add 1-5% motor oil as lubricant.
4. 1 part Magnesium Oxide nanoparticles (20-100 nm size range)+2 parts Kaolin+water to form a thick paste, add 1-5% motor oil as lubricant.
5. 10 parts Kaolin+1 part Phenolic binder+water to form a paste. The water soluble phenolic binder is made by the Plenco corporation (USA), add 1-5% motor oil as lubricant.
6. 10 parts Magnesium Oxide+1 part Phenolic binder+water to form a paste. Add 1-5% motor oil as lubricant.

For a Support Structure than can be Easily Removed after Drying:

Talc powder with water added to form a thick paste (no binders used), optionally add 1-5% motor oil as lubricant.

The above formulations can be used as casting shells right after drying or can be baked to increase strength. Baking is typically done at temperatures of 200 to 500 degrees C. Higher temperature baking can be used to further increase strength but some dimensional changes may occur.

When the system is used to make permanent ceramic parts harder ceramic materials such as alumina or Zirconia can be used, mixed with water to form a paste and about 1% to 10% of binder such as Poly Vinyl Alcohol. Such parts are sintered at high temperatures (1500 to 2000 degrees C.) after drying to achieve full strength. This process is well known.

The shells made had a wall thickness from 1 to 30 mm, however walls are build up similar to corrugated cardboard, with significant air spaces incorporated inside wall.

The internal inserts in the mold (to create cavities) can be built up with large voids in order to speed up clean-out and reduce cost as well as reduce drying times.

The 3D printing process allows adding periodic pinholes in the shell, which helps gasses escape. The surface tension of the metal normally prevents the molten metal from filling these pinholes. The molten metal entering the pinholes solidifies because of the low heat capacity of the minute amount of metal. The pinholes are typically from 0.1 mm to 1 mm. The shell can be made as one piece, similar to an investment casting shell, from several pieces similar to shell moulding or from several pieces plus inserted cores. The different pieces can be held together during the casting process or bonded together, after drying, with the same ceramic paste used to make them or a specialized bonding paste having a higher concentration of binders. Other ceramic adhesives can be use as well for bonding shells parts.

A complete fabrication system may comprise a 3D printer 10 generating a casting shell 7. Shell 7 is moved (manually or automatically) to a freeze dryer having a vacuum tight chamber. A fan can be used to blow chilled air from this chamber to 3D printer 10 before the vacuum is applied. After drying the shell can be moved (manually or automatically) to casting station. Filling shell 7 from bottom instead of top offers some advantages, as known in the art of foundry work.

1. A method of using a 3D printer for creating ceramic shells used in casting metallic objects, method comprising the steps of:
creating a paste comprising of a ceramic powder, a binder and water,
extruding the said paste via a nozzle fed from a positive displacement pump, said pump located in proximity to the nozzle,
moving said nozzle in three dimensions relative to a three dimensional casting shell created from the extruded paste,
drying the casting shell using freeze drying, and
using the dry shell as a casting shell for metal casting.

2. A 3D printer for printing ceramic casting shells from a water based ceramic paste using an extrusion nozzle and a positive displacement pump located in close proximity to the nozzle, said ceramic material having a hardness of less than 5 on the Mho scale, and said shell being freeze dried after printing.

3. A method as in claim 1 wherein the supports needed in the process of printing the ceramic shell are made of a ceramic material which is weaker than the shell material.

4. A method as in claim 2 wherein the supports needed in the process of printing the ceramic shell are made of a ceramic material which is weaker than the shell material.

5. A method as in claim 1 wherein the supports needed in the process of printing the ceramic shell are made of a ceramic material of a different color than the shell material.

6. A method as in claim 2 wherein the supports needed in the process of printing the ceramic shell are made of a ceramic material of a different color than the shell material

7. A method as in claim 1 wherein the shell is made from a ceramic powder, binder and water while the support material is made from a ceramic powder and water.

8. A method as in claim 2 wherein the shell is made from a ceramic powder, binder and water while the support material is made from a ceramic powder and water.

9. A method as in claim 1 wherein the ceramic material is talc.

10. A method as in claim 1 wherein the ceramic material is magnesium oxide.

11. A method as in claim 1 wherein the binder is sodium silicate.

12. A method as in claim 1 wherein the binder is aluminum oxide hydroxide.

13. A method as in claim 1 wherein the binder is an organic polymer.

14. A method as in claim 1 wherein the binder is a phenolic resin.
